(19) United States
(12) Patent Application Publication
(10) Pub. No.: US 2024/0151088 A1
(43) Pub. Date: May 9, 2024

(54) Tailgate Adjustment Strap

(71) Applicant: Brian McCarthy, Forest Ranch, CA (US)

(72) Inventor: Brian McCarthy, Forest Ranch, CA (US)

(21) Appl. No.: 18/487,251

(22) Filed: Oct. 16, 2023

Related U.S. Application Data
(60) Provisional application No. 63/420,945, filed on Oct. 31, 2022.

(51) Int. Cl. E05F 5/06

(52) U.S. Cl. CPC E05F 5/06; B62D 33/0273

(57) ABSTRACT

A tailgate adjustment strap that allows a user to adjust the tailgate of a truck between a fully open and a fully closed position. The tailgate latch connector is secured to the base belt via a loop sewn into the first end of the base belt. The striker connector extends outwardly from one end of the cam buckle and includes a plate having a central aperture which varies in diameter. The striker is an elongated rod extending inwardly toward a middle of the truck bed from its attachment point to the inner side panel of the truck bed. A disc is disposed on an end of the striker and has a greater diameter than the central aperture to prevent the striker connector from disconnecting from the striker.

### CROSS REFERENCE TO RELATED APPLICATIONS

This is a U.S. Non-Provisional Patent Application that claims the benefit of Co-Pending U.S. Provisional Patent Application No. 63/420,945, filed Oct. 31, 2022, which is incorporated herein by reference in its entirety.

### BACKGROUND OF THE INVENTION

The present disclosure relates to a strap and, more particularly, to a tailgate adjustment strap.

Many pickup trucks and similar vehicles include a rear bed that is accessible via a tailgate which is pivotally connected to the rear end of the rear bed of a truck. The tailgate may move between a closed vertical position, where the upper end of the tailgate secures to the side panels of the truck bed of the truck, and an open horizontal position where the tailgate extends outwardly and is aligned with the surface of the truck bed. When transporting larger items with a pickup truck, it may be necessary to move the tailgate to the open position so that a portion of the item extends outwardly past the rear end of the truck bed.

However, this method of accommodating larger items has drawbacks. The item must be secured within the truck bed by some additional fastening means, which may not always be available. Such additional fastening means may also fail, causing the item to slide out of the back of the truck bed, since it is not retained by the inner side of the tailgate door. Some items may be accommodated by leaning them atop the upper edge of the tailgate when the tailgate is in the closed position. However, this method often still requires additional fasteners to secure the item, and the item may potentially damage the finish on the upper edge of the tailgate.

Accordingly, a need remains to provide a tailgate adjustment strap that allows the user to adjust the tailgate of a truck to any desired position between the fully open and fully closed positions. In this way, additional space may be provided for larger items, while the partially closed tailgate still retains the item within the truck bed.

In light of the devices disclosed in the known art, it is submitted that the present invention substantially diverges in functional and design elements from the known tailgate adjustment strap art and consequently it is clear that there is a need in the tailgate adjustment strap art for an improvement to existing tailgate adjustment straps. In this regard the present invention substantially fulfills these needs.

### SUMMARY OF THE INVENTION

In view of the foregoing disadvantages inherent in the types of tailgate adjustment straps and similar devices now present in the known art, the present invention provides a tailgate adjustment strap that may allow a user to adjust the tailgate of a vehicle to any desired position between the fully open and fully closed positions.

The present system comprises a tailgate adjustment strap that includes a base belt having a first end and a second end, a tailgate latch connector attached to the first end of the base belt, and a cam buckle slidably disposed along a length of the base belt.

Another object of the present invention is to provide a tailgate adjustment strap that is quick and easily assembled and disassembled onto a truck.

Another object of the present invention is to provide a tailgate adjustment strap that adjustably allows the user to adjust the tailgate of a truck to any desired position between the fully open and fully closed positions.

Another object of the present invention is to provide a tailgate adjustment strap that allows the user to adjust the tailgate of a truck to any desired position between the fully open and fully closed positions without the use of additional fasteners.

Another object of the present invention is to provide a tailgate adjustment strap that is made of relatively durable materials to facilitate reliability and strength.

Other objects, features, and advantages of the present invention will become apparent from the following description taken in conjunction with the accompanying figures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the tailgate adjustment strap.

FIG. 2 shows a rear perspective view of the tailgate adjustment strap.

FIG. 3 shows a side perspective view of the tailgate adjustment strap.

FIG. 4 shows a perspective view of a cam buckle of the tailgate adjustment strap.

FIG. 5 shows a perspective view of a cam buckle secured to a striker connector of the tailgate adjustment strap.

FIG. 6 shows an environmental perspective view of the tailgate adjustment strap in use with a tailgate of a truck.

FIG. 7 shows a front perspective view of a first tailgate adjustment strap and a second adjustment strap.

### DETAILED DESCRIPTION OF THE INVENTION

Reference is made herein to the attached drawings. Like reference numerals are used throughout the drawings to depict like or similar elements of the tailgate adjustment strap. The figures are intended for representative purposes only and should not be considered to be limiting in any respect.

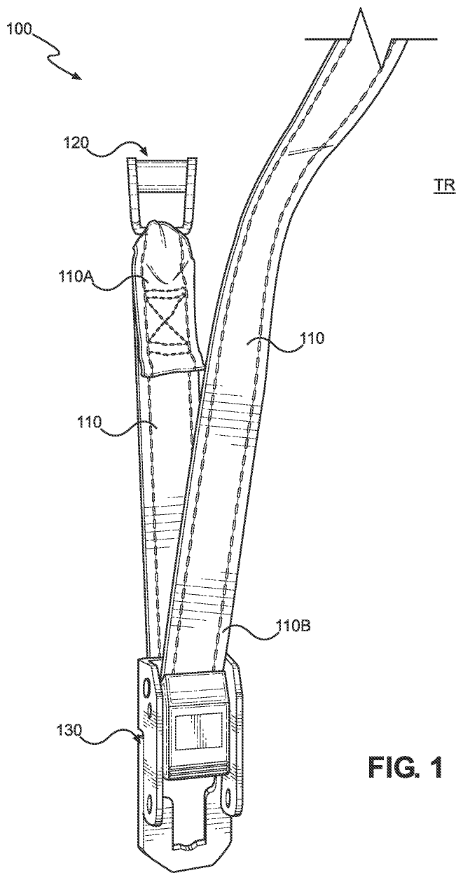

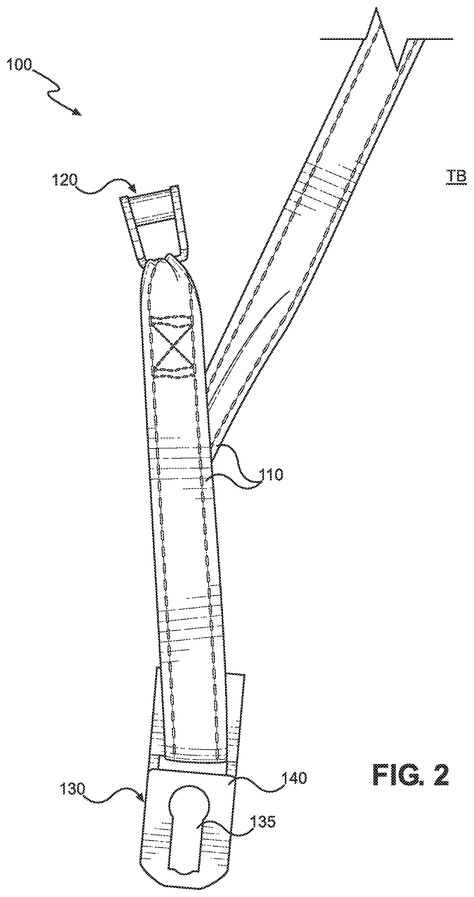

FIGS. 1-3 shows various perspective views of the tailgate adjustment strap 100.

The tailgate adjustment strap 100 may include an base belt 110, a tailgate latch connector 120, a cam buckle 130, and a strike connector 140.

The base belt 110 may include a first end 110A and a second end 110B. The base belt 110 may be made of a material selected from the group consisting of metal, plastic, fabric, or the like.

The tailgate latch connector 120 may be attached to the first end 110A of the base belt 110. The tailgate latch connector 120 may be adapted to be removably secured to a tailgate latch TL of a truck TR. The tailgate latch connector 120 may be secured to the base belt 110 via a loop 112 sewn into the first end 110A of the base belt 110. In other embodiments, the tailgate latch connector 120 may be removably secured to the base belt 110 or connected via any other suitable means.

The cam buckle 130 may be slidably disposed along the length of the base belt 110. The cam buckle 130 may include a strike connector 140 that is configured to removable secure the cam buckle 130 to a striker 134 on the rear portion of the side panel of the truck bed TB. The strike connector 140 may be welded to or otherwise permanently attached to the cam buckle 130. In other embodiments, the strike connector 140 may include a clip (not shown) or some other type of fastener to secure the strike connector 140 to the cam buckle 130 in order to convert it for use as a tailgate adjustment strap 100.

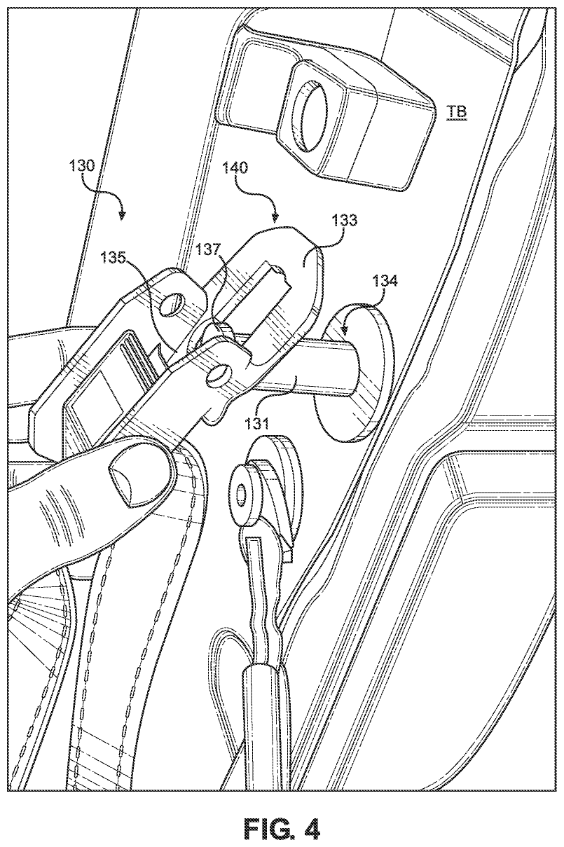

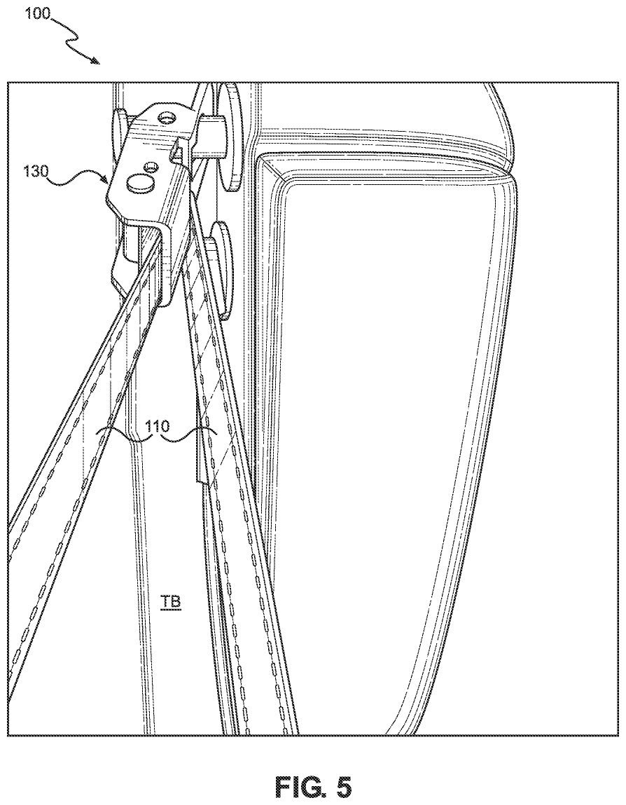

Referring now to FIGS. 4 and 5, there are shown perspective views of the cam buckle 130 securing to the striker 134 on the side panel of the truck bed TB. In the shown embodiment, the strike connector 140 extends outwardly from one end of the cam buckle 130. The strike connector 140 may include a plate 133 having a central aperture 135 which varies in diameter. The central aperture 135 may receive the striker 134, which is an elongated rod 131 extending inwardly toward the middle of the truck bed TB from its attachment point to the inner side panel of the truck bed TB. The strike connector 140 may then be slid downward so the smaller diameter portion receives the striker 134. A disc 137 may be disposed on an end of the striker 134 and has a greater diameter than the smaller diameter portion of the central aperture 135. This prevents the connector from disconnecting from the striker 134 unless the user actively raises the strike connector 140 to the larger diameter portion and slides it over the disc 137. In this way, the cam buckle 130 and the base belt 110 are adapted to be effectively secured to an inner side panel of the truck bed TB and will remain so during transport.

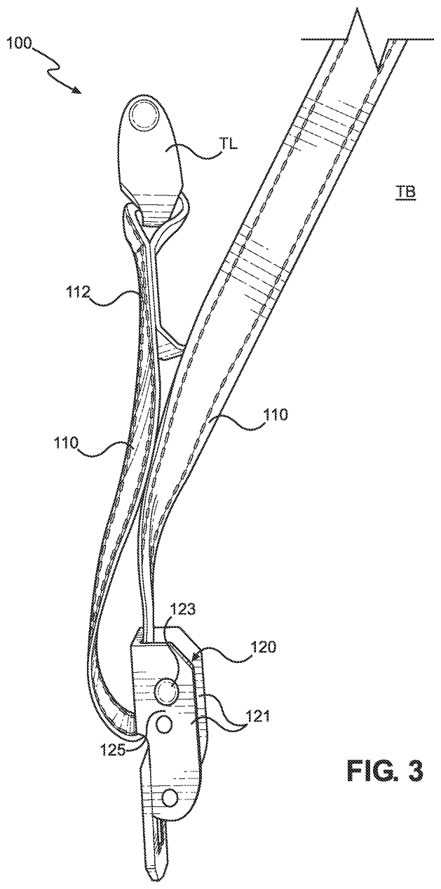

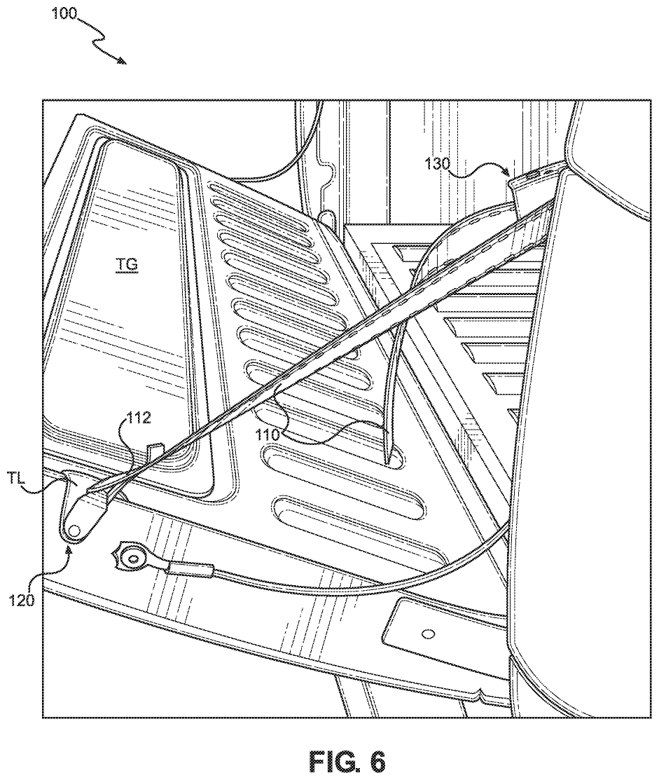

FIGS. 3 and 6 show an environmental perspective view of the tailgate adjustment strap 100 in use with a tailgate TG of a truck TR.

The tailgate latch connector 120 may be adapted to be secured to a tailgate latch TL disposed on the side edge of the tailgate TG includes a pair of side plates 121 connected via a small cylinder 123 at their distal ends. This defines an aperture 125 that is sized and configured to receive the tailgate latch TL. The aperture 125 may have a varying diameter similar to the strike connector 140 on the cam buckle 130 to ensure that the tailgate latch connector 120 remains secured to the tailgate latch TL during transport.

In operation, the user secures the strike connector 140 and the tailgate latch connector 120 to their respective attachment points. The cam buckle 130 may then be moved to the open position. This allows the base belt 110 to be pulled through the cam buckle 130 until the length of base belt 110 between the cam buckle 130 and tailgate latch connector 120 is at a desired length that achieves a desired position for the tailgate TG. The cam buckle 130 may then be closed to lock in the length of the base belt 110 and thus maintain the selected position of the tailgate. In this way, the cam buckle 130 secures the tailgate at a desired angle selected by the user.

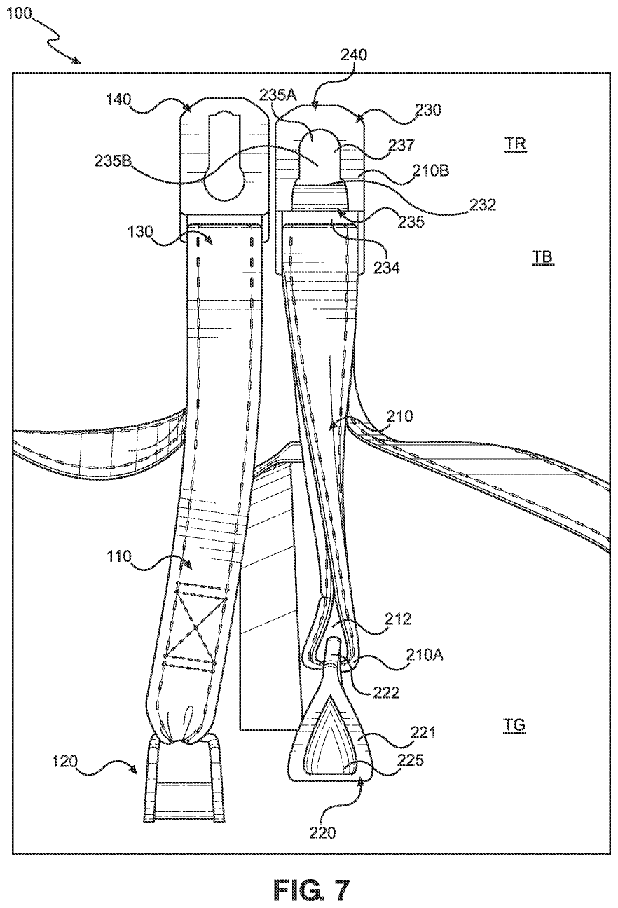

FIG. 7 shows a front perspective view of a first tailgate adjustment strap 100 and a second adjustment strap 200.

The second adjustment strap 200 may a base belt 210, a tailgate latch connector 220, and a cam buckle 230.

The base belt 210 may include a first end 210A and a second end 210B. The base belt 210 may be made of a material selected from the group consisting of metal, plastic, fabric, or the like.

The tailgate latch connector 220 may be attached to the first end 210A of the base belt 210. The tailgate latch connector 220 may be adapted to be removably secured to a tailgate latch TL (not shown) of a truck TR. The tailgate latch connector 220 may be secured to the base belt 210 via a loop 212 sewn into a loop extension 222 from the tailgate latch connector 220 that receives the loop 212. In other embodiments, the tailgate latch connector 220 may be removably secured to the base belt 210 or connected via any other suitable means.

The tailgate latch connector 220 may be adapted to be secured to a tailgate latch TL (not shown) disposed on the side edge of the tailgate TG that includes a pair of side plates 221 that define an aperture 225 that is sized and configured to receive the tailgate latch TL (not shown).

The aperture 225 may have a varying diameter to ensure that the tailgate latch connector 220 remains secured to the tailgate latch TL during transport.

The cam buckle 230 may secure to the second end of the base belt 210B with a buckle loop 232 disposed on an end of the cam buckle 230. More specifically, the second end of the base belt 210B may include a loop 234 that is extended through the buckle loop 232.

The cam buckle 230 may include the strike connector 240 to secure the striker 236 to the cam buckle 230. The strike connector 240 may be welded to or otherwise permanently attached to the cam buckle 230.

The strike connector 240 may include a central aperture 235 which varies in diameter.

The central aperture 235 receives the striker 236, the strike connector 240 may then be slid downward to receive the striker 236. A disc 236 may be disposed on an end of the striker 236 and have a greater diameter than a smaller diameter portion 235A of the central aperture 235. This prevents the strike connector 240 from disconnecting from the striker 236 unless the user actively raises the strike connector 240 to a larger diameter portion 235B and slides it over the disc 237. In this way, the cam buckle 230 and the base belt 210 are adapted to be effectively secured to an inner side panel of the truck bed TB and will remain so during transport.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tailgate adjustment strap, comprising:
a base belt having a first end and a second end;
a tailgate latch connector attached to the first end of the base belt; and
a cam buckle slidably disposed along a length of the base belt.

2. The tailgate adjustment strap, according to claim 1, wherein the base belt is made of a material selected from the group consisting of metal, plastic, or fabric.

3. The tailgate adjustment strap, according to claim 1, wherein the tailgate latch connector is adapted to be removably secured to a tailgate latch of a truck.

4. The tailgate adjustment strap, according to claim 3, wherein the tailgate latch connector is secured to the base belt via a loop sewn into the first end of the base belt.

5. The tailgate adjustment strap, according to claim 3, wherein the tailgate latch connector is adapted to be secured to the tailgate latch disposed on a side edge of the tailgate.

6. The tailgate adjustment strap, according to claim 5, wherein the tailgate latch connector includes a pair of side plates connected via a small cylinder at their distal ends to define an aperture that is sized and configured to receive the tailgate latch.

7. The tailgate adjustment strap, according to claim 4, wherein the tailgate latch connector is secured to the base belt via a loop sewn into the first end of the base belt directly into an extension from the tailgate latch connector that receives the loop.

8. The tailgate adjustment strap, according to claim 1, wherein the cam buckle is secured to the second end of the base belt with a buckle loop disposed on an end of the cam buckle.

9. The tailgate adjustment strap, according to claim 1, wherein the cam buckle secures a striker on a side panel of a truck bed.

10. The tailgate adjustment strap, according to claim 9, wherein the cam buckle and the base belt are adapted to be effectively secured to an inner side panel of the truck bed and will remain so during transport.

11. The tailgate adjustment strap, according to claim 1, the second end of the base belt includes a loop that is extended through the buckle loop.

12. The tailgate adjustment strap, according to claim 1, further comprising a striker connector permanently attached to the cam buckle.

13. The tailgate adjustment strap, according to claim 12, wherein the cam buckle includes the striker connector that is configured to removable secure the cam buckle to the striker on the rear portion of the side panel of the truck bed.

14. The tailgate adjustment strap, according to claim 12, wherein the striker connector extends outwardly from one end of the cam buckle.

15. The tailgate adjustment strap, according to claim 12, wherein the striker connector includes a plate having a central aperture which varies in diameter.

16. The tailgate adjustment strap, according to claim 15, wherein the central aperture receives the striker.

17. The tailgate adjustment strap, according to claim 16, wherein the striker is an elongated rod extending inwardly toward a middle of the truck bed from its attachment point to the inner side panel of the truck bed.

18. The tailgate adjustment strap, according to claim 15, wherein the striker connector is slid downward so the central aperture receives the striker.

19. The tailgate adjustment strap, according to claim 1, further comprising a disc is disposed on an end of the striker and has a greater diameter than the central aperture to prevent the striker connector from disconnecting from the striker.

20. The tailgate adjustment strap, according to claim 19, wherein a user actively raises the striker connector to the larger diameter portion and slides it over the disc.
